(19) United States
(12) Patent Application Publication
(10) Pub. No.: US 2024/0345733 A1
(43) Pub. Date: Oct. 17, 2024

(54) MEMORY SYSTEM PROCEDURE DETECTION AND LATENCY REDUCTION

(71) Applicant: Micron Technology, Inc., Boise, ID (US)

(72) Inventors: Yanhua Bi, Shanghai (CN); Luca Porzio, Casalnuovo (NA) (IT); Hao Yu, Shanghai (CN)

(21) Appl. No.: 18/629,685

(22) Filed: Apr. 8, 2024

Related U.S. Application Data
(60) Provisional application No. 63/495,801, filed on Apr. 13, 2023.

(51) Int. Cl. G06F 3/06

(52) U.S. Cl. CPC G06F 3/0611; G06F 3/0659; G06F 3/0679

(57) ABSTRACT

Methods, systems, and devices for checkpoint procedure detection and latency reduction are described. A memory system may determine that a checkpoint procedure has been initiated. Based on determining that the checkpoint procedure has been initiated, the memory system may write metadata associated with the checkpoint procedure to a non-volatile memory using a first type of write operation that has lower latency than a second type of write operation supported by the non-volatile memory. The memory system may also write checkpoint information about the metadata to the non-volatile memory using the first type of write operation.

### CROSS REFERENCE

The present application for patent claims priority to U.S. Patent Application No. 63/495,801 by Bi et al., entitled “MEMORY SYSTEM PROCEDURE DETECTION AND LATENCY REDUCTION,” filed Apr. 13, 2023, which is assigned to the assignee hereof, and which is expressly incorporated by reference in its entirety herein.

### FIELD OF TECHNOLOGY

The following relates to one or more systems for memory, including memory system procedure detection and latency reduction.

### BACKGROUND

Memory devices are widely used to store information in various electronic devices such as computers, user devices, wireless communication devices, cameras, digital displays, and the like. Information is stored by programming memory cells within a memory device to various states. For example, binary memory cells may be programmed to one of two supported states, often corresponding to a logic 1 or a logic 0. In some examples, a single memory cell may support more than two possible states, any one of which may be stored by the memory cell. To access information stored by a memory device, a component may read (e.g., sense, detect, retrieve, identify, determine, evaluate) the state of one or more memory cells within the memory device. To store information, a component may write (e.g., program, set, assign) one or more memory cells within the memory device to corresponding states.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), 3-dimensional cross-point memory (3D cross point), not-or (NOR) and not-and (NAND) memory devices, and others. Memory devices may be described in terms of volatile configurations or non-volatile configurations. Volatile memory cells (e.g., DRAM) may lose their programmed states over time unless they are periodically refreshed by an external power source. Non-volatile memory cells (e.g., NAND) may maintain their programmed states for extended periods of time even in the absence of an external power source.

### BRIEF DESCRIPTION OF THE DRAWINGS

FIG. 1 illustrates an example of a system that supports checkpoint procedure detection and latency reduction in accordance with examples as disclosed herein.

FIG. 2 illustrates an example of a system that supports checkpoint procedure detection and latency reduction in accordance with examples as disclosed herein.

FIG. 3 illustrates an example of a process flow that supports checkpoint procedure detection and latency reduction in accordance with examples as disclosed herein.

FIG. 4 illustrates an example of a process flow that supports procedure latency reduction in accordance with examples as disclosed herein.

FIG. 5 illustrates a block diagram of a memory system that supports checkpoint procedure detection and latency reduction in accordance with examples as disclosed herein.

FIGS. 6 and 7 illustrate flowcharts showing a method or methods that support checkpoint procedure detection and latency reduction in accordance with examples as disclosed herein.

### DETAILED DESCRIPTION

A memory system (e.g., a memory system that is part of a filesystem) may use checkpoint procedures to intermittently save information that helps the memory system recover from a sudden power failure or system crash. A checkpoint procedure may include various stages in which different types of information are saved to a non-volatile memory of the memory system. During a checkpoint procedure, the memory system may refrain from servicing requests from a host system that are unrelated to the checkpoint procedure. For example, the memory system may delay servicing incoming requests for user data until after the checkpoint procedure has completed. But ignoring requests from the host system may result in inconsistent or delayed operation of the system, negatively impacting user experience.

According to the techniques described herein, a memory system may improve user experience by implementing various techniques to reduce the duration of checkpoint procedures. For example, upon detecting initiation of a checkpoint procedure, the memory system may use a first type of write operation (e.g., a write operation for writing single-level cells (SLCs)) that has lower latency than a second type of write operation (e.g., a write operation for writing multiple-level cells (MLCs)) to write information associated with the checkpoint procedure. Additionally or alternatively, the memory system may reduce the duration of the checkpoint procedure by pausing one or background operations, extending the size of an address tracking table, and/or responding prematurely to certain commands associated with the checkpoint procedure.

In addition to checkpoint procedures, a memory system may implement other types of procedures, such as writeback procedures and swap procedures. In a writeback procedure, data from a cache of a host system may be received by the memory system and written to the non-volatile memory. In a swap procedure, data from a volatile memory (e.g., main memory, primary memory, working memory) of the memory system may be written to the non-volatile memory to free up space in the volatile memory. A memory system may use the techniques described herein to reduce the latency of writeback procedures and swap procedures, which may improve the performance of the system.

In addition to applicability in memory systems as described herein, techniques for improved memory system procedure detection and latency reduction may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by facilitating memory system procedure detection and latency reduction, which may decrease processing or latency times, improve response times, or otherwise improve user experience, among other benefits.

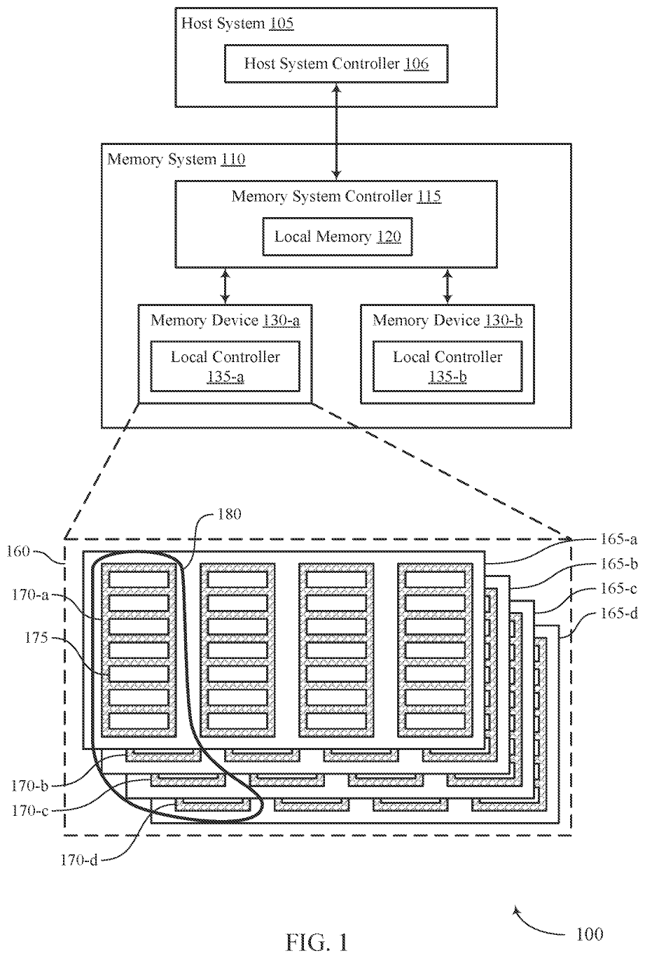

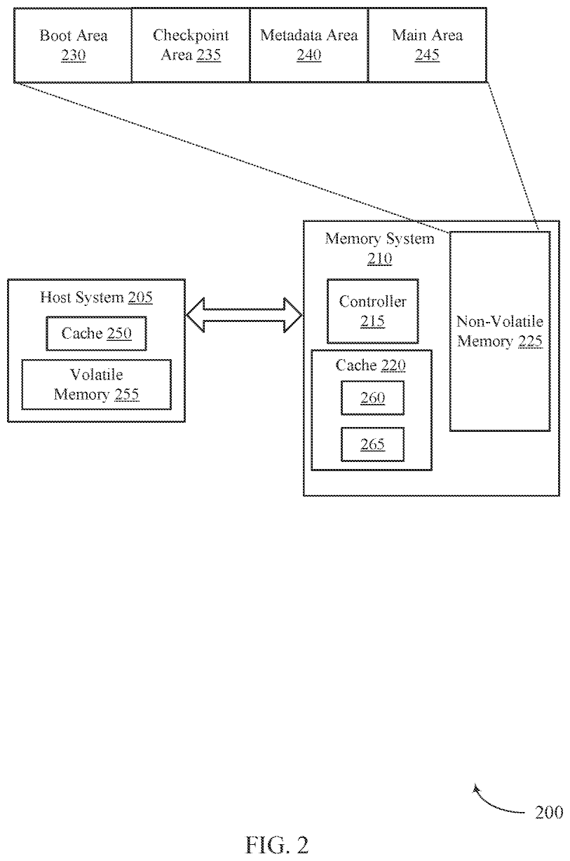

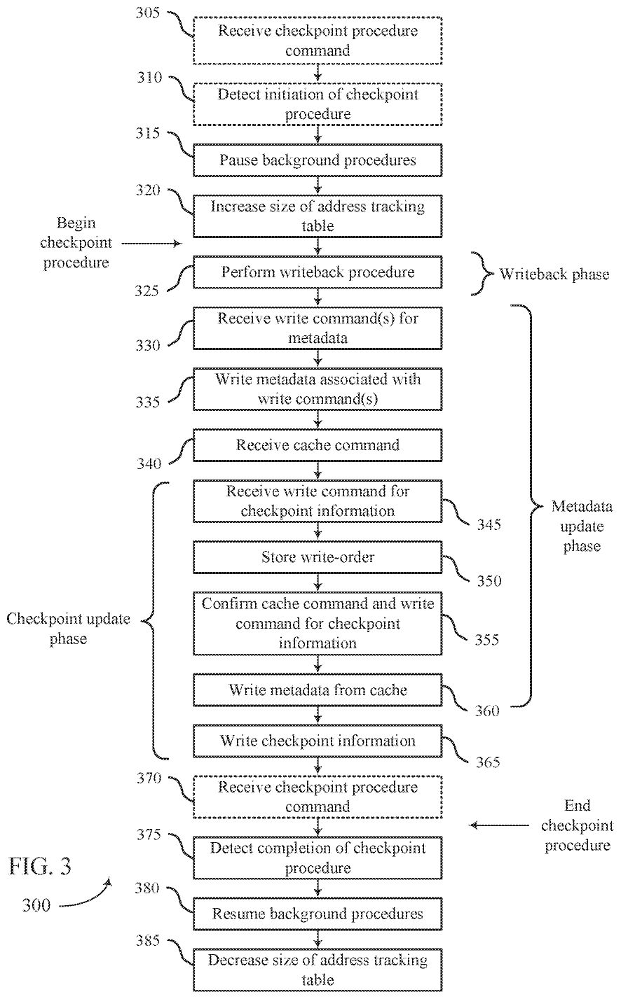

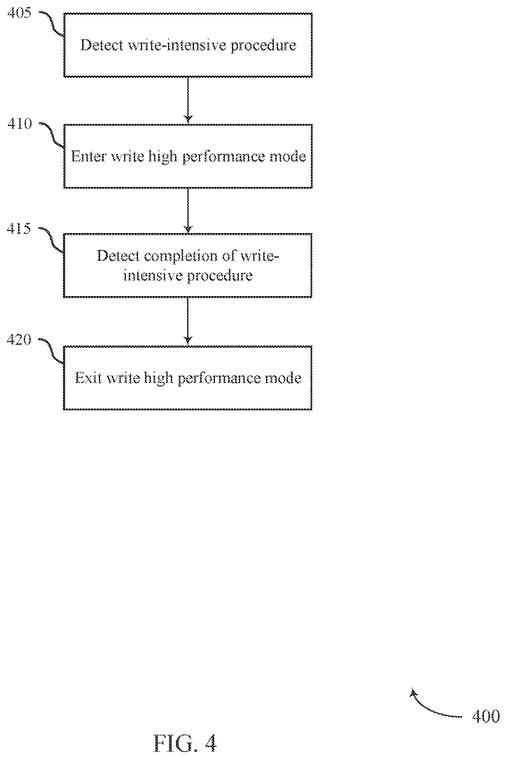

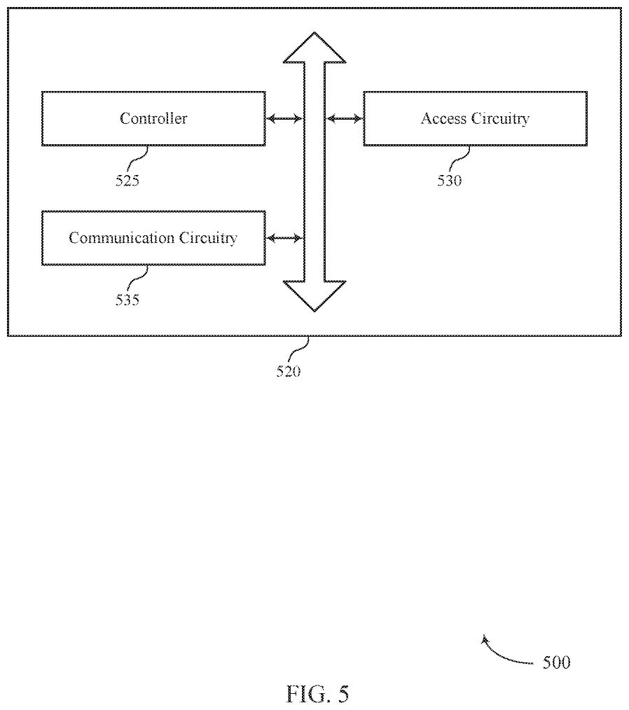

Features of the disclosure are initially described in the context of systems, devices, and circuits with reference to FIGS. 1 through 2. Features of the disclosure are described in the context of process flows with reference to FIGS. 3 and 4. These and other features of the disclosure are further illustrated by and described in the context of an apparatus diagram and flowchart that relate to checkpoint procedure detection and latency reduction with reference to FIGS. 5 through 7.

FIG. 1 illustrates an example of a system 100 that supports checkpoint procedure detection and latency reduction in accordance with examples as disclosed herein. The system 100 includes a host system 105 coupled with a memory system 110. The system 100 may be included in a computing device such as a desktop computer, a laptop computer, a network server, a mobile device, a vehicle (e.g., airplane, drone, train, automobile, or other conveyance), an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other possibilities.

The system 100 may be included in a computing device such as a desktop computer, a laptop computer, a network server, a mobile device, a vehicle (e.g., airplane, drone, train, automobile, or other conveyance), an Internet of Things (IoT) enabled device, an embedded computer (e.g., one included in a vehicle, industrial equipment, or a networked commercial device), or any other computing device that includes memory and a processing device.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (RAM) (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on a same die or within a same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, planes 165 may refer to groups of blocks 170, and in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in a same page 175 may share (e.g., be coupled with) a common word line, and memory cells in a same string may share (e.g., be coupled with) a common digit line (which may alternatively be referred to as a bit line).

For some NAND architectures, memory cells may be read and programmed (e.g., written) at a first level of granularity (e.g., at the page level of granularity) but may be erased at a second level of granularity (e.g., at the block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. Invalid data may be data that is outdated due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

The memory cells of a memory device 130 may store different quantities of bits depending on the write operation used to write the memory cells. For example, a first type of write operation, referred to as an SLC write operation, may be used to write a single bit of information to a memory cell. A second type of write operation, referred to as an MLC write operation, may be used to write multiple bits (e.g., two or more) to a memory cell. An SLC write operation may involve larger write margins and have a lower latency than an MLC write operation. A memory cell written using an SLC write operation (so that the memory cell stores a single bit of information) may be referred to as an SLC memory cell. Similarly, a memory cell written using an MLC write operation (so that the memory cell stores two or more bits of information) may be referred to as an MLC memory cell. Examples of MLC cells include bi-level cells (BLC) (written with two bits of information), tri-level cells (TLC) (written with three bits of information), and quad-level cells (QLCs) (written with four bits of information).

As noted, the memory system 110 may include one or more address mapping tables, such as L2P tables, that map logical addresses (e.g., addresses associated with commands from the host system 105) to physical addresses (e.g., memory locations of the memory devices 130). Rather than updating the L2P tables on a command-by-command basis (e.g., in response to each received command), which may be inefficient due to moving the L2P tables between the memory devices 130 and the local memory 120, the memory system 110 may use an address tracking table to accumulate L2P mappings for multiple commands. The memory system 110 may use the address tracking table to update the L2P tables if the address tracking table fills up (e.g., reaches capacity). The capacity of the address tracking table may also be referred to as the size of the address tracking table and may represent the quantity of L2P mappings the address tracking table is capable of storing. An address tracking table may also be referred to as an internal changelog or other suitable terminology.

From time to time, the host system 105 may initiate a checkpoint procedure at the memory system 110 so that the memory system 110 saves information for recovering after an unexpected loss of power or system crash. During the checkpoint procedure, the memory system 110 may ignore requests from the host system 105 that are unrelated to the checkpoint procedure (e.g., so as not to disrupt the checkpoint procedure), which may cause operational delays that negatively impact user experience.

To improve user experience, the memory system 110 may implement various techniques that reduce the latency of a checkpoint procedure. For instance, the memory system 110 may increase the size of the address tracking table so that the memory system 110 can avoid updating the L2P tables (which may otherwise divert resources from the checkpoint procedure) during the checkpoint procedure. Additionally or alternatively, the memory system 110 may use an SLC write operation, rather than a slower MLC write operation, to write information associated with the checkpoint procedure. Additionally or alternatively, the memory system 110 may reduce the latency of the checkpoint procedure by pausing one or more background operations (which may allow the memory system 110 to divert more resources to the checkpoint procedure) and/or by pulling forward confirmation of one or more commands associated with the background operation (which may allow the host system 105 to signal completion of the checkpoint procedure sooner than otherwise).

Although initially described with reference to checkpoint procedures, the techniques described herein can be used to reduce the latency of other types of procedures, such as writeback procedures and swap procedures. For example, upon detecting a writeback procedure (or a swap procedure), the memory system 110 may switch to SLC write operations (rather than using slower MLC write operations) for the data associated with the writeback procedure (or the swap procedure). Additionally or alternatively, the memory system 110 may pause one or more background operations during the writeback procedure (or the swap procedure). Additionally or alternatively, the memory system 110 may expand the size of the address tracking table during the writeback procedure (or the swap procedure).

So, the memory system 110 may implement one or more of the latency reduction techniques described herein upon detecting initiation of a write-intensive procedure that involves (or is expected to involve) a threshold quantity or rate of write operations.

The system 100 may include any quantity of non-transitory computer readable media that support checkpoint procedure detection and latency reduction. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

FIG. 2 illustrates an example of a system 200 that supports procedure detection and latency reduction in accordance with examples as disclosed herein. The system 200 may be an example of a system 100 as described with reference to FIG. 1 or aspects thereof. The system 200 may include a memory system 210 that is configured to store data for the host system 205. The memory system 210 and the host system 205 may be examples of the memory system 110 and the host system 105, respectively. In some examples, the system 200 may be or include a file system, such as a flash-friendly file system (F2FS).

The memory system 210 may include a controller 215, which may be an example of the memory system controller 115, and a cache 220, which may be an example of the local memory 120. The controller 215 may execute commands received from the host system 205 and control the movement of information within the memory system 210. The cache 220 may store information for writing to the non-volatile memory 225 or for sending to the host system 205. The cache 220 may be a volatile-type of memory, such as DRAM or SRAM.

The non-volatile memory 225 may be configured with various areas (e.g., contiguous blocks of memory) for different types of information. For example, the non-volatile memory 225 may include a boot area 230, a checkpoint area 235, a metadata area 240, and a main area 245, among other potential areas. The boot area 230 may be configured to store information for operating the memory system 210, such as the type of the memory system 210, the LBA range of the non-volatile memory 225, the size and range of the other areas of the non-volatile memory 225, and the like. The checkpoint area 235 may be configured to store checkpoint information, which may refer to information about the metadata written to the metadata area 240 during a checkpoint procedure.

The metadata area 240 may be configured to store metadata for data files stored in the non-volatile memory 225 or for operating the non-volatile memory 225. The metadata area 240 may include sub-areas such as a segment information table (SIT) area (which may store validity information for the main area 245), a node address table (NAT) area (which may store a block address table to locate the node blocks in the main area 245), and a segment summary area (SSA) (which may store owner information, such as parent node information, for the main area 245). The main area 245 may be configured to store information, such as user data (e.g., data files).

Among other types of procedures, the memory system 210 may implement checkpoint procedures. A checkpoint procedure may include multiple phases in which different information is stored in the non-volatile memory 225. For example, a checkpoint procedure may include a writeback phase in which data for one or more data files is written from the cache 220 to the main area 245 of the non-volatile memory 225 (e.g., so that the remaining phases of the checkpoint procedure are operated with a clean cache 220). The checkpoint procedure may also include a metadata update phase (which may occur or be initiated after the data update phase) in which metadata (e.g., for one or more data files) is written to the metadata area 240 of the non-volatile memory 225. During the metadata phase, the memory system 210 may write metadata received from the host system 205 to the non-volatile memory 225 (e.g., in response to one or more write commands from the host system 205) and may write metadata from the cache 220 to the non-volatile memory 225 (e.g., in response to a cache command from the host system 205).

In some examples, the memory system 210 may delay confirmation of the cache command for the metadata until after some or all of the cached metadata has been written to the non-volatile memory 225. In other examples, the memory system 210 may reduce the duration of the checkpoint procedure by confirming the cache command for the metadata before some of all of the cached metadata is written to the non-volatile memory 225. Confirmation of a command may refer to transmission of a message that indicates the operation associated with the command has been completed. In some examples, the cache command may be a sync_cache command that instructs the memory system 210 to transfer content from the cache 220 to the non-volatile memory 225.

The checkpoint procedure may also include a checkpoint update phase (which may occur or be initiated after the metadata update phase) in which checkpoint information about the metadata is written to the checkpoint area 235 of the non-volatile memory 225. For example, the checkpoint information may indicate which entries in the metadata area 240 have updated metadata that was written during the metadata phase of the checkpoint procedure. The host system 205 may initiate the checkpoint phase by transmitting a write command for the checkpoint information (e.g., a reliable write command, a write command with the force unit access (FUA) flag set).

In some examples, the memory system 210 may delay confirmation of the write command for the checkpoint information until after some or all of the checkpoint information has been written to the non-volatile memory 225. In other examples, the memory system 210 may reduce the duration of the checkpoint procedure by confirming the write command for the checkpoint information before some or all of the checkpoint information is written to the non-volatile memory 225.

To reduce operational interruptions that arise during a checkpoint procedure, the memory system 210 may implement one or more techniques to reduce the latency of the checkpoint procedure. To do so, the memory system 210 may first detect initiation of the checkpoint procedure.

In some examples, the memory system 210 may detect initiation of the checkpoint procedure based on (e.g., by detecting) the receipt of one or more write commands associated with metadata. For example, the memory system 210 may detect initiation of a checkpoint procedure if the memory system 210 receives a write command with a tag or group identifier (ID) that is associated with metadata. In such an example, the memory system 210 may detect initiation of the checkpoint procedure during the metadata update phase (e.g., after the data update phase) of the checkpoint procedure. The memory system 210 may confirm initiation of the checkpoint procedure based on (e.g., by detecting) the write command(s) for the metadata being followed by a cache command (e.g., a sync_cache command) and a write command (e.g., a write command with the FUA flag set) for the checkpoint information. If the write commands associated with the metadata are followed by one or more access commands unassociated with the checkpoint procedure (e.g., write commands or read commands for user data), the memory system 210 may determine that detection of the checkpoint procedure was erroneous (e.g., a false-positive).

In some examples, the memory system 210 may detect initiation of the checkpoint procedure based on (e.g., by detecting) the receipt of a command that indicates initiation of the checkpoint procedure. The command may be a vendor-defined command, a write command with a group ID specific to the checkpoint procedure, a small computer system interface (SCSI) command specific to the checkpoint procedure, a flag, or a descriptor access, among other options. In such an example, the memory system 210 may detect initiation of the checkpoint procedure before the data update phase of the checkpoint procedure.

After detecting initiation of a checkpoint procedure, the memory system 210 may implement one or more techniques to reduce the latency of the checkpoint procedure. For instance, the memory system 210 may reduce the latency of the checkpoint procedure by using SLC write operations to write information associated with the checkpoint procedure (e.g., data from the writeback phase, metadata from the metadata update phase, checkpoint information from the checkpoint update phase) to the non-volatile memory. In some examples, the memory system 210 may reserve portions (e.g., one or more blocks) of the non-volatile memory for the SLC write operations. For example, the memory system 210 may reserve blocks of memory that are configured to support SLC write operations for the information from the checkpoint procedure. Using SLC write operations, rather than longer-latency MLC write operations, may reduce the amount of time it takes the memory system 210 to write the information associated with the checkpoint procedure to the non-volatile memory 225.

Additionally or alternatively, the memory system 210 may reduce the latency of the checkpoint procedure by pausing one or more background operations, such as a wear-leveling operation in which information in the non-volatile memory 225 is shifted from one portion of the non-volatile memory to another portion of the non-volatile memory to reduce wear-out. Other examples of background procedures that the memory system 210 may pause include background refresh procedures, garbage collection procedures, scrub procedures, block scan procedures, and health monitoring procedures. Pausing background operations may allow the memory system 210 to concentrate additional resources (e.g., processing resources, access circuitry, buffers) on the checkpoint procedure, which may help reduce the latency of the checkpoint procedure.

Additionally or alternatively, the memory system 210 may reduce the latency of the checkpoint procedure by increasing the size of the address tracking table used to populate L2P tables for the non-volatile memory 225. For example, the memory system 210 may expand the address tracking table so that the address tracking table can accommodate x address mappings instead of y address mappings, where x>y. Increasing the size of the address tracking table may allow the memory system 210 to wait longer in between updating the L2P tables (a procedure which may divert resources from the checkpoint procedure), which in turn may increase the likelihood that the memory system 210 can avoid updating the L2P tables until after completion of the checkpoint procedure.

In some examples, the memory system 210 may divert resources reserved for read operations to enable expansion of the address tracking table. For example, the memory system 210 may use portions of the cache 220 reserved for a table (e.g., physical page table) used for read operations as an extension for the address mapping table.

Additionally or alternatively, the memory system 210 may reduce the latency of the checkpoint procedure by increasing the amount of space available for address mapping information that is used to perform address translation. For example, the memory system 210 may expand the amount of space in the cache 220 used for address mapping information. Address mapping information may refer to L2P table information that maps logical addresses associated with access commands from the host system 205 to physical addresses of the non-volatile memory 225. So, the memory system 210 may use address mapping information to perform address translation for access commands.

Due to the large size of the L2P table, the memory system 210 may store the L2P table in the non-volatile memory 225. To perform address translation for received access commands, the memory system 210 may retrieve portions of the L2P table (e.g., address mapping information) from the non-volatile memory 225 and load the portions into an area of the cache 220 (e.g., L2P area 260) that is reserved for address mapping information. But the size of the L2P area 260 may limit the amount of address mapping information that can be loaded into the cache 220, which in turn may increase the latency of address translation (e.g., because missing address mapping information must be retrieved from the non-volatile memory 225, which takes additional time).

To reduce the latency of address translation (and thus the latency for satisfying an access command) the memory system 210 may expand the amount of space used for address mapping information by evicting some information from another area of the cache 220 and using that area to store address mapping information. For example, the memory system 210 may evict cursor information for MLC write operations from the MLC area 265 and use the MLC area 265 as an extension of the L2P area 260. The cursor information in the MLC area 265 may be information that facilitates MLC write operations for a portion (e.g., block) of the non-volatile memory 225. For instance, the cursor information may indicate properties and parameters of a block and the content stored in the block (e.g., management layout information, NAND (e.g., block) physical position, block metadata, parity data, redundancy data). The memory system 210 may evict the cursor information for the MLC write operations based on determining that the memory system 210 is using SLC write operations for the current write-intensive procedure (e.g., checkpoint procedure, writeback procedure, swap procedure). In some examples, the cursor information for MLC write operations may be referred to as metadata or other suitable terminology.

Additionally or alternatively, the memory system 210 may reduce the latency of the checkpoint procedure by shifting forward confirmation for one or more commands associated with the checkpoint procedure. For example, rather than confirming the cache command after flushing (e.g., writing) the metadata from the cache 220 to the non-volatile memory 225, the memory system 210 may confirm the cache command after flagging the order in which the metadata from the cache 220 and the checkpoint information are to be written (even if the metadata from the cache 220 has yet to be written to the non-volatile memory 225). And rather than confirming the write command for the checkpoint information after writing the checkpoint information to the non-volatile memory 225, the memory system 210 may confirm the write command after flagging the order in which the metadata from the cache 220 and the checkpoint information are to be written (even if the checkpoint information has yet to be written to the non-volatile memory 225).

In some examples, the memory system 210 may flag the write-order for the metadata and the checkpoint information by storing an indication of the write-order for the metadata and the checkpoint information. Confirming the cache command and the write command for the checkpoint information before writing (or finishing writing) the cached metadata and the checkpoint information to the non-volatile memory may allow the host system 205 to signal completion of the checkpoint procedure earlier than otherwise, which in turn may reduce the duration of the checkpoint procedure.

After determining that the checkpoint procedure has been completed, the memory system 210 may lift one or more of the mechanisms used to reduce the latency of the checkpoint procedure. For example, if the memory system 210 paused any background procedures during the checkpoint procedure, the memory system 210 may resume those background procedures. If the memory system 210 increased the size of the address tracking table, the memory system 210 may decrease (e.g., to its original size) the size of the address tracking table.

In some examples, the memory system 210 may implement one or more of the technique described herein to reduce the latency of a writeback procedure. In a writeback procedure, the host system 205 determine that a periodic timer has expired (or that available space in a cache is below a threshold) and transfer data from the cache (e.g., the cache 250) of the host system 205 to the memory system 210 for writing to the non-volatile memory 225. For example, the host system 205 may maintain a list of write commands and associated data for sending to the memory system 210 in the cache, and may periodically (or upon detection that available space in the cache is below a threshold) flush the cache by performing write operations to the memory system 210. So, during a writeback procedure, the memory system 210 may receive data from the cache 250 of the host system 205 along with write commands (e.g., a high volume of write commands) for the data. The write commands may share a common identifier (e.g., group ID) that is associated with the writeback procedure, which may allow the memory system 210 to detect the write commands that belong to the writeback procedure. Thus, the memory system 210 may detect initiation of a writeback procedure based on receiving a set of write commands that share a group identifier associated with the writeback procedure.

In some examples, the memory system 210 may implement one or more of the technique described herein to reduce the latency of a swap procedure. In a swap procedure, the host system 205 may transfer data (e.g., data associated with a first application) from a volatile memory (e.g., volatile memory 255, which may be a primary memory or main memory) of the host system 205 to the memory system 210 to free up space in the volatile memory for new data (e.g., data associated with a second application). The host system 205 may initiate the swap procedure based on (e.g., in response) detecting that the capacity of the volatile memory is insufficient for the new data and may write the data from a portion of the volatile memory to a swap area of the non-volatile memory 225. The swap area of the non-volatile memory 225 may be a statically configured range of addresses that is reserved for swap procedures. So, during a swap procedure, the memory system 210 may receive data from the volatile memory of the host system 205 along with write commands (e.g., a high volume of write commands) for the data that indicate the swap area. Accordingly, the memory system 210 may detect initiation of a swap procedure based on receiving a set of write commands that target (e.g., indicate, are associated with) the swap area of the non-volatile memory 225. In general, the swap area of the non-volatile memory 225 may be reserved for application data (e.g., as opposed to file data).

Thus, the memory system 210 may improve user experience by reducing the latency associated with various procedures and access commands.

FIG. 3 illustrates an example of a process flow 300 that supports checkpoint procedure detection and latency reduction in accordance with examples as disclosed herein. The process flow 300 may be implemented by a memory system such as the memory system 110 or the memory system 210 as described with reference to FIGS. 1 and 2, respectively. The process flow 300 may be implemented by a memory system to reduce the latency of a checkpoint procedure.

Aspects of the process flow 300 may be implemented by a controller, among other components. Additionally or alternatively, aspects of the process flow 300 may be implemented as instructions stored in memory (e.g., firmware stored in a memory coupled with a memory system). For example, the instructions, when executed by a controller (e.g., the controller 215), may cause the controller to perform the operations of the process flow 300.

At 305, a checkpoint procedure command (e.g., a command initiating a checkpoint procedure) may be received. At 310, initiation of the checkpoint procedure may be determined. If the checkpoint procedure command is received at 305, initiation of the checkpoint procedure may be determined based on (e.g., by detecting) receipt of the checkpoint procedure command. The checkpoint procedure command may be a vendor-defined command, a write command with a group ID specific to the checkpoint procedure, an SCSI command specific to the checkpoint procedure, a flag, or a descriptor access, among other options. If the checkpoint procedure command is not received at 305, the operations at 310 (e.g., detection of the checkpoint procedure) may occur after 330. In such an example, initiation of the checkpoint procedure may be determined based on (e.g., by detecting) receipt of one or more write commands for metadata.

At 315, one or more background operations (e.g., a wear-leveling operation) may be paused based on (e.g., in response to) detecting initiation of the checkpoint procedure, which may help reduce the latency of the checkpoint procedure. At 320, the size of an address tracking table may be increased based on (e.g., in response to) detecting initiation of the checkpoint procedure, which may help reduce the latency of the checkpoint procedure. At 325, a writeback procedure may be performed (e.g., during a writeback phase of the checkpoint procedure). For example, data from the cache 220 may be written to the non-volatile memory 225. In some examples, the cached data may be written to the non-volatile memory 225 using a first type of write operation (e.g., an SLC write operation) that has a lower latency than a second type of write operation (e.g., an MLC write operation) supported by the memory system, which may help reduce the latency of the checkpoint procedure.

At 330, one or more write commands for metadata may be received (e.g., as part of the metadata update phase). If not already detected, the memory system may detect initiation of the checkpoint procedure based on (e.g., by detecting) receipt of the one or more write commands for metadata. For example, the memory system may detect initiation of the checkpoint procedure based on the memory system receiving one or more write commands with a tag or group ID that is associated with metadata. Thus, the memory system may detect initiation of the checkpoint procedure during the metadata update phase of the checkpoint procedure.

At 335, metadata associated with the write command(s) may be written to the non-volatile memory 225 based on (e.g., due to) the write command(s). In some examples, the metadata may be written to the non-volatile memory 225 using a first type of write operation (e.g., an SLC write operation) that has a lower latency than a second type of write operation (e.g., an MLC write operation) supported by the memory system, which may help reduce the latency of the checkpoint procedure.

At 340, a cache command (e.g., a sync_cache command) to transfer content (e.g., metadata) from the cache 220 to the non-volatile memory 225 may be received. At 345, a write command to write checkpoint information for the updated metadata may be received (e.g., as part of the checkpoint update phase). The write command for the checkpoint information may indicate initiation of the checkpoint phase and may be a reliable write command or a write command with the FUA flag set, among other options.

At 350, the write-order for the cached metadata and the checkpoint information may be stored (e.g., to ensure that the cached metadata is written to the non-volatile memory 225 before the checkpoint information is written to the non-volatile memory 225). The write-order for the cached metadata and the checkpoint information may be stored based on (e.g., due to) receipt of the cache command and the write command for the checkpoint information.

At 355, a confirmation for the cache command and a confirmation for the write command may be transmitted. The confirmations may be transmitted based on (e.g., in response to) storing the indication of the write-order (e.g., before the memory system starts or finishes writing the cached metadata and the checkpoint information to the non-volatile memory 225), which may allow the host system to signal the end of the checkpoint procedure earlier than waiting until the cached metadata and the checkpoint information is completely written to the non-volatile memory 225). Alternatively, the confirmations may be transmitted after the cached metadata and the checkpoint information is completely written to the non-volatile memory 225 (e.g., after 365).

At 360, the metadata in the cache 220 may be written to the non-volatile memory 225 (e.g., based on the cache command). In some examples, the cached metadata (e.g., all of the cached metadata) may be written to the non-volatile memory 225 using a first type of write operation (e.g., an SLC write operation) that has a lower latency than a second type of write operation (e.g., an MLC write operation) supported by the memory system, which may help reduce the latency of the checkpoint procedure. In some examples, the cached metadata may be written to blocks of the non-volatile memory 225 that were reserved for SLC write operations before initiation of the checkpoint procedure.

At 365, the checkpoint information for the metadata (e.g., the metadata write at 335 and 360) may be written to the non-volatile memory (e.g., based on the write command for the checkpoint information). In some examples, the checkpoint information may be written to the non-volatile memory 225 using a first type of write operation (e.g., an SLC write operation) that has a lower latency than a second type of write operation (e.g., an MLC write operation) supported by the memory system, which may help reduce the latency of the checkpoint procedure. In some examples, the checkpoint information may be written to blocks of the non-volatile memory 225 that were reserved for SLC write operations before initiation of the checkpoint procedure.

At 370, a checkpoint procedure command (e.g., a command indicating completion of the checkpoint procedure) may be received. At 375, completion of the checkpoint procedure may be determined. If the checkpoint procedure command is received at 370, completion of the checkpoint procedure may be determined based on (e.g., due to) receipt of the checkpoint procedure command. If the checkpoint procedure command is not received at 370, the operations at 375 may be based on (e.g., due to) receipt of the cache command followed by the write command for the checkpoint information, or based on (e.g., due to) receipt of one or more access commands (e.g., a read command, a write command) unassociated with the checkpoint procedure.

At 380, the one or more background procedures paused at 315 may be resumed based on (e.g., in response to) determining that the checkpoint procedure has completed. At 385, the size of the address tracking table may be reduced (e.g., restored to its original size) based on (e.g., in response to) determining that the checkpoint procedure has completed.

Thus, the memory system may reduce the latency of a checkpoint procedure. Although described in the context of a checkpoint procedure, the latency reducing techniques described with reference to FIG. 3 may be implemented for other types of write-intensive procedures, such as writeback procedures and swap procedures.

Alternative examples of the foregoing may be implemented, where some operations are performed in a different order than described, are performed in parallel, or are not performed at all. In some cases, operations may include additional features not mentioned herein, or further operations may be added. Additionally, certain operations may be performed multiple times or certain combinations of operations may repeat or cycle.

FIG. 4 illustrates an example of a process flow 400 that supports procedure detection and latency reduction in accordance with examples as disclosed herein. The process flow 400 may be implemented by a memory system such as the memory system 110 or the memory system 210 as described with reference to FIGS. 1 and 2, respectively. The process flow 400 may be implemented by a memory system to reduce the latency of a write-intensive procedure.

Aspects of the process flow 400 may be implemented by a controller, among other components. Additionally or alternatively, aspects of the process flow 400 may be implemented as instructions stored in memory (e.g., firmware stored in a memory coupled with a memory system). For example, the instructions, when executed by a controller (e.g., the controller 215), may cause the controller to perform the operations of the process flow 400.

At 405, a write-intensive procedure may be detected. For example, the memory system may detect a checkpoint procedure, a writeback procedure, or a swap procedure. The memory system may detect a checkpoint procedure as described with reference to FIG. 3. The memory system may detect a writeback procedure based on (e.g., in response to) receiving a set of write commands that share a group ID associated with the writeback procedure. The memory system may detect a swap procedure based on (e.g., in response to) receiving a set of write commands that indicate the swap area of the non-volatile memory.

At 410, a high performance mode may be entered based on (e.g., in response to) detecting the write-intensive procedure. As part of the high performance mode, the memory system may implement one or more of the latency reduction techniques described herein. For example, the memory system may use SLC write operations (rather than slower MLC write operations) to write data associated with the write-intensive procedure. Additionally or alternatively, the memory system may pause (e.g., halt before completion) one or more background operations until the write-back procedure has been completed. Pausing the background operation(s) may allow the memory system to divert resources from the background operation(s) to the write-intensive operation. Additionally or alternatively, the memory system may increase (e.g., temporarily, until the write-intensive procedure is completed) the size of the address tracking table (e.g., so that address translation can occur with fewer retrievals of address mapping information from the non-volatile memory). Additionally or alternatively, the memory system may expand the portion of the cache memory used for address mapping information by treating the MLC area 265 as an extension of the L2P area 260. To do so, the memory system may transfer the cursor information for MLC write operations from the MLC area 265 to the non-volatile memory so that the MLC area 265 can be used for address mapping information (e.g., by writing address mapping information to the area).

At 415, the completion of the write-intensive procedure may be detected. At 420, the high performance mode may be exited based on detecting the completion of the write-intensive procedure.

Thus, the memory system may reduce the latency of a write-intensive procedure. Alternative examples of the foregoing may be implemented, where some operations are performed in a different order than described, are performed in parallel, or are not performed at all. In some cases, operations may include additional features not mentioned herein, or further operations may be added. Additionally, certain operations may be performed multiple times or certain combinations of operations may repeat or cycle.

FIG. 5 illustrates a block diagram 500 of a memory system 520 that supports checkpoint procedure detection and latency reduction in accordance with examples as disclosed herein. The memory system 520 may be an example of aspects of a memory system as described with reference to FIGS. 1 through 4. The memory system 520, or various components thereof, may be an example of means for performing various aspects of checkpoint procedure detection and latency reduction as described herein. For example, the memory system 520 may include a controller 525, an access circuitry 530, a communication circuitry 535, or any combination thereof. Each of these components may communicate, directly or indirectly, with one another (e.g., via one or more buses).

The controller 525 may be configured as or otherwise support a means for determining whether a checkpoint procedure has been initiated, where the checkpoint procedure includes a metadata update phase in which metadata for a file is written to a non-volatile memory, and a checkpoint update phase in which checkpoint information about the metadata is written to the non-volatile memory. The access circuitry 530 may be configured as or otherwise support a means for writing, based at least in part on determining that the checkpoint procedure has been initiated, the metadata to the non-volatile memory using a first type of write operation that has lower latency than a second type of write operation supported by the non-volatile memory. In some examples, the access circuitry 530 may be configured as or otherwise support a means for writing, based at least in part on determining that the checkpoint procedure has been initiated and based at least in part on writing the metadata, the checkpoint information about the metadata to the non-volatile memory using the first type of write operation.

In some examples, the communication circuitry 535 may be configured as or otherwise support a means for receiving a write command that includes a flag associated with the metadata, where initiation of the checkpoint procedure is determined based at least in part on the write command.

In some examples, the communication circuitry 535 may be configured as or otherwise support a means for receiving a command that indicates initiation of the checkpoint procedure, where initiation of the checkpoint procedure is determined based at least in part on the command.

In some examples, the controller 525 may be configured as or otherwise support a means for reserving a first set of memory blocks for writing the metadata using the first type of write procedure. In some examples, the controller 525 may be configured as or otherwise support a means for reserving a second set of memory blocks for writing the checkpoint information using the first type of write procedure, where the initiation of the checkpoint procedure is determined after reserving the first and second sets of memory blocks.

In some examples, the controller 525 may be configured as or otherwise support a means for pausing an operation based at least in part on determining that the checkpoint procedure has been initiated. In some examples, the controller 525 may be configured as or otherwise support a means for resuming the operation based at least in part on determining that the checkpoint procedure has ended.

In some examples, the controller 525 may be configured as or otherwise support a means for increasing, based at least in part on determining that the checkpoint procedure has been initiated, a size of an address tracking log that associates logical addresses from access commands with physical addresses of the non-volatile memory.

In some examples, the controller 525 may be configured as or otherwise support a means for decreasing the size of the address tracking log based at least in part on writing the metadata and the checkpoint information.

In some examples, the communication circuitry 535 may be configured as or otherwise support a means for receiving, during the checkpoint procedure, a cache command to transfer content from a cache to the non-volatile memory, where a portion of the metadata is written to the non-volatile memory based at least in part on the cache command. In some examples, the communication circuitry 535 may be configured as or otherwise support a means for receiving, during the checkpoint procedure, a write command to write the checkpoint information to the non-volatile memory, where the checkpoint information is written to the non-volatile memory based at least in part on the command.

In some examples, the access circuitry 530 may be configured as or otherwise support a means for storing, based at least in part on the cache command and the write command, an indication to write the portion of the metadata to the non-volatile memory before writing the checkpoint information to the non-volatile memory. In some examples, the communication circuitry 535 may be configured as or otherwise support a means for transmitting a confirmation for the cache command based at least in part on storing the indication, where the confirmation is transmitted before the portion of the metadata is written to the non-volatile memory.

In some examples, the communication circuitry 535 may be configured as or otherwise support a means for transmitting a confirmation for the write command based at least in part on storing the indication, where the confirmation for the write command is transmitted before the checkpoint information is written to the non-volatile memory.

In some examples, the first type of write operation stores a first quantity of bits per cell and the second type of write operation stores a second quantity of bits per cell, the second quantity larger than the first quantity.

In some examples, the controller 525 may be configured as or otherwise support a means for determining whether a checkpoint procedure has been initiated, where the checkpoint procedure includes a metadata update phase in which metadata for a file is written to a non-volatile memory, and a checkpoint update phase in which checkpoint information about the metadata is written to the non-volatile memory. In some examples, the controller 525 may be configured as or otherwise support a means for increasing, based at least in part on determining that the checkpoint procedure has been initiated, a size of an address tracking log that associates logical addresses from access commands with physical addresses of the non-volatile memory. In some examples, the access circuitry 530 may be configured as or otherwise support a means for writing, metadata and the checkpoint information about the metadata to the non-volatile memory based at least in part on determining that the checkpoint procedure has been initiated. In some examples, the controller 525 may be configured as or otherwise support a means for decreasing, based at least in part on writing the metadata and the checkpoint information using the increased size of the address tracking log, the size of the address tracking log.

In some examples, the communication circuitry 535 may be configured as or otherwise support a means for receiving a write command that includes a flag associated with the metadata, where initiation of the checkpoint procedure is determined based at least in part on the write command.

In some examples, the communication circuitry 535 may be configured as or otherwise support a means for receiving a command that indicates initiation of the checkpoint procedure, where initiation of the checkpoint procedure is determined based at least in part on the command.

In some examples, to support writing the metadata and the checkpoint information to the non-volatile memory, the access circuitry 530 may be configured as or otherwise support a means for writing, based at least in part on determining that the checkpoint procedure has been initiated, the metadata and the checkpoint information to the non-volatile memory using a first type of write operation that has lower latency than a second type of write operation supported by the non-volatile memory.

In some examples, the controller 525 may be configured as or otherwise support a means for pausing an operation based at least in part on determining that the checkpoint procedure has been initiated. In some examples, the controller 525 may be configured as or otherwise support a means for resuming the operation based at least in part on writing the metadata and the checkpoint information to the non-volatile memory.

In some examples, the communication circuitry 535 may be configured as or otherwise support a means for receiving a command that indicates completion of the checkpoint procedure, where the size of the address tracking log is decreased based at least in part on the command.

In some examples, the communication circuitry 535 may be configured as or otherwise support a means for receiving a read command, or a write command for user data, where the where the size of the address tracking log is decreased based at least in part on the read command, or the write command for user data.

In some examples, the communication circuitry 535 may be configured as or otherwise support a means for receiving, during the checkpoint procedure, a cache command to transfer content from a cache to the non-volatile memory and a write command to write the checkpoint information to the non-volatile memory, where a portion of the metadata is written to the non-volatile memory based at least in part on the cache command, the checkpoint information is written to non-volatile memory based at least in part on the command, and the size of the address tracking log is decreased based at least in part on cache command and the write command.

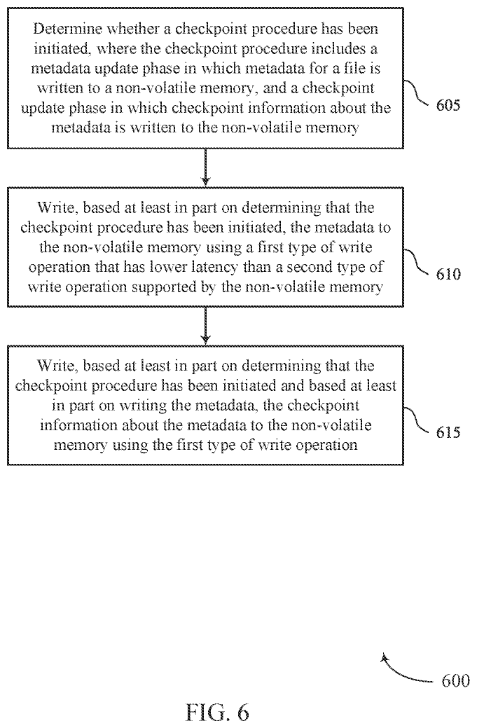

FIG. 6 illustrates a flowchart showing a method 600 that supports checkpoint procedure detection and latency reduction in accordance with examples as disclosed herein. The operations of method 600 may be implemented by a memory system or its components as described herein. For example, the operations of method 600 may be performed by a memory system as described with reference to FIGS. 1 through 5. In some examples, a memory system may execute a set of instructions to control the functional elements of the device to perform the described functions. Additionally, or alternatively, the memory system may perform aspects of the described functions using special-purpose hardware.

At 605, the method may include determining whether a checkpoint procedure has been initiated, where the checkpoint procedure includes a metadata update phase in which metadata for a file is written to a non-volatile memory, and a checkpoint update phase in which checkpoint information about the metadata is written to the non-volatile memory. The operations of 605 may be performed in accordance with examples as disclosed herein. In some examples, aspects of the operations of 605 may be performed by a controller 525 as described with reference to FIG. 5.

At 610, the method may include writing, based at least in part on determining that the checkpoint procedure has been initiated, the metadata to the non-volatile memory using a first type of write operation that has lower latency than a second type of write operation supported by the non-volatile memory. The operations of 610 may be performed in accordance with examples as disclosed herein. In some examples, aspects of the operations of 610 may be performed by an access circuitry 530 as described with reference to FIG. 5.

At 615, the method may include writing, based at least in part on determining that the checkpoint procedure has been initiated and based at least in part on writing the metadata, the checkpoint information about the metadata to the non-volatile memory using the first type of write operation. The operations of 615 may be performed in accordance with examples as disclosed herein. In some examples, aspects of the operations of 615 may be performed by an access circuitry 530 as described with reference to FIG. 5.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for determining whether a checkpoint procedure has been initiated, where the checkpoint procedure includes a metadata update phase in which metadata for a file is written to a non-volatile memory, and a checkpoint update phase in which checkpoint information about the metadata is written to the non-volatile memory; writing, based at least in part on determining that the checkpoint procedure has been initiated, the metadata to the non-volatile memory using a first type of write operation that has lower latency than a second type of write operation supported by the non-volatile memory; and writing, based at least in part on determining that the checkpoint procedure has been initiated and based at least in part on writing the metadata, the checkpoint information about the metadata to the non-volatile memory using the first type of write operation.

Aspect 2: The method, apparatus, or non-transitory computer-readable medium of aspect 1, further including operations, features, circuitry, logic, means, or instructions, or any combination thereof for receiving a write command that includes a flag associated with the metadata, where initiation of the checkpoint procedure is determined based at least in part on the write command.

Aspect 3: The method, apparatus, or non-transitory computer-readable medium of any of aspects 1 through 2, further including operations, features, circuitry, logic, means, or instructions, or any combination thereof for receiving a command that indicates initiation of the checkpoint procedure, where initiation of the checkpoint procedure is determined based at least in part on the command.

Aspect 4: The method, apparatus, or non-transitory computer-readable medium of any of aspects 1 through 3, further including operations, features, circuitry, logic, means, or instructions, or any combination thereof for reserving a first set of memory blocks for writing the metadata using the first type of write procedure and reserving a second set of memory blocks for writing the checkpoint information using the first type of write procedure, where the initiation of the checkpoint procedure is determined after reserving the first and second sets of memory blocks.

Aspect 5: The method, apparatus, or non-transitory computer-readable medium of any of aspects 1 through 4, further including operations, features, circuitry, logic, means, or instructions, or any combination thereof for pausing an operation based at least in part on determining that the checkpoint procedure has been initiated and resuming the operation based at least in part on determining that the checkpoint procedure has ended.

Aspect 6: The method, apparatus, or non-transitory computer-readable medium of any of aspects 1 through 5, further including operations, features, circuitry, logic, means, or instructions, or any combination thereof for increasing, based at least in part on determining that the checkpoint procedure has been initiated, a size of an address tracking log that associates logical addresses from access commands with physical addresses of the non-volatile memory.

Aspect 7: The method, apparatus, or non-transitory computer-readable medium of aspect 6, further including operations, features, circuitry, logic, means, or instructions, or any combination thereof for decreasing the size of the address tracking log based at least in part on writing the metadata and the checkpoint information.

Aspect 8: The method, apparatus, or non-transitory computer-readable medium of any of aspects 1 through 7, further including operations, features, circuitry, logic, means, or instructions, or any combination thereof for receiving, during the checkpoint procedure, a cache command to transfer content from a cache to the non-volatile memory, where a portion of the metadata is written to the non-volatile memory based at least in part on the cache command and receiving, during the checkpoint procedure, a write command to write the checkpoint information to the non-volatile memory, where the checkpoint information is written to the non-volatile memory based at least in part on the command.

Aspect 9: The method, apparatus, or non-transitory computer-readable medium of aspect 8, further including operations, features, circuitry, logic, means, or instructions, or any combination thereof for storing, based at least in part on the cache command and the write command, an indication to write the portion of the metadata to the non-volatile memory before writing the checkpoint information to the non-volatile memory and transmitting a confirmation for the cache command based at least in part on storing the indication, where the confirmation is transmitted before the portion of the metadata is written to the non-volatile memory.

Aspect 10: The method, apparatus, or non-transitory computer-readable medium of aspect 9, further including operations, features, circuitry, logic, means, or instructions, or any combination thereof for transmitting a confirmation for the write command based at least in part on storing the indication, where the confirmation for the write command is transmitted before the checkpoint information is written to the non-volatile memory.

Aspect 11: The method, apparatus, or non-transitory computer-readable medium of any of aspects 1 through 10, where the first type of write operation stores a first quantity of bits per cell and the second type of write operation stores a second quantity of bits per cell, the second quantity larger than the first quantity.

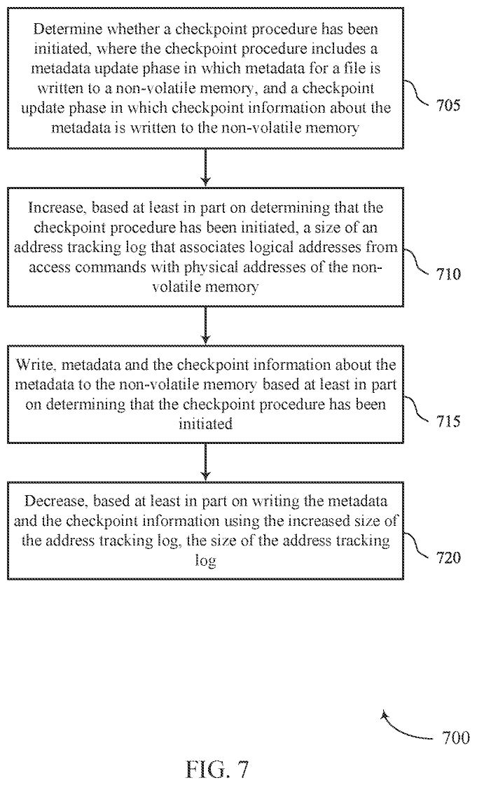

FIG. 7 illustrates a flowchart showing a method 700 that supports checkpoint procedure detection and latency reduction in accordance with examples as disclosed herein. The operations of method 700 may be implemented by a memory system or its components as described herein. For example, the operations of method 700 may be performed by a memory system as described with reference to FIGS. 1 through 5. In some examples, a memory system may execute a set of instructions to control the functional elements of the device to perform the described functions. Additionally, or alternatively, the memory system may perform aspects of the described functions using special-purpose hardware.

At 705, the method may include determining whether a checkpoint procedure has been initiated, where the checkpoint procedure includes a metadata update phase in which metadata for a file is written to a non-volatile memory, and a checkpoint update phase in which checkpoint information about the metadata is written to the non-volatile memory. The operations of 705 may be performed in accordance with examples as disclosed herein. In some examples, aspects of the operations of 705 may be performed by a controller 525 as described with reference to FIG. 5.

At 710, the method may include increasing, based at least in part on determining that the checkpoint procedure has been initiated, a size of an address tracking log that associates logical addresses from access commands with physical addresses of the non-volatile memory. The operations of 710 may be performed in accordance with examples as disclosed herein. In some examples, aspects of the operations of 710 may be performed by a controller 525 as described with reference to FIG. 5.

At 715, the method may include writing, metadata and the checkpoint information about the metadata to the non-volatile memory based at least in part on determining that the checkpoint procedure has been initiated. The operations of 715 may be performed in accordance with examples as disclosed herein. In some examples, aspects of the operations of 715 may be performed by an access circuitry 530 as described with reference to FIG. 5.

At 720, the method may include decreasing, based at least in part on writing the metadata and the checkpoint information using the increased size of the address tracking log, the size of the address tracking log. The operations of 720 may be performed in accordance with examples as disclosed herein. In some examples, aspects of the operations of 720 may be performed by a controller 525 as described with reference to FIG. 5.

In some examples, an apparatus as described herein may perform a method or methods, such as the method 700. The apparatus may include features, circuitry, logic, means, or instructions (e.g., a non-transitory computer-readable medium storing instructions executable by a processor), or any combination thereof for performing the following aspects of the present disclosure:

Aspect 12: A method, apparatus, or non-transitory computer-readable medium including operations, features, circuitry, logic, means, or instructions, or any combination thereof for determining whether a checkpoint procedure has been initiated, where the checkpoint procedure includes a metadata update phase in which metadata for a file is written to a non-volatile memory, and a checkpoint update phase in which checkpoint information about the metadata is written to the non-volatile memory; increasing, based at least in part on determining that the checkpoint procedure has been initiated, a size of an address tracking log that associates logical addresses from access commands with physical addresses of the non-volatile memory; writing, metadata and the checkpoint information about the metadata to the non-volatile memory based at least in part on determining that the checkpoint procedure has been initiated; and decreasing, based at least in part on writing the metadata and the checkpoint information using the increased size of the address tracking log, the size of the address tracking log.

Aspect 13: The method, apparatus, or non-transitory computer-readable medium of aspect 12, further including operations, features, circuitry, logic, means, or instructions, or any combination thereof for receiving a write command that includes a flag associated with the metadata, where initiation of the checkpoint procedure is determined based at least in part on the write command.

Aspect 14: The method, apparatus, or non-transitory computer-readable medium of any of aspects 12 through 13, further including operations, features, circuitry, logic, means, or instructions, or any combination thereof for receiving a command that indicates initiation of the checkpoint procedure, where initiation of the checkpoint procedure is determined based at least in part on the command.

Aspect 15: The method, apparatus, or non-transitory computer-readable medium of any of aspects 12 through 14, where writing the metadata and the checkpoint information to the non-volatile memory includes operations, features, circuitry, logic, means, or instructions, or any combination thereof for writing, based at least in part on determining that the checkpoint procedure has been initiated, the metadata and the checkpoint information to the non-volatile memory using a first type of write operation that has lower latency than a second type of write operation supported by the non-volatile memory.

Aspect 16: The method, apparatus, or non-transitory computer-readable medium of any of aspects 12 through 15, further including operations, features, circuitry, logic, means, or instructions, or any combination thereof for pausing an operation based at least in part on determining that the checkpoint procedure has been initiated and resuming the operation based at least in part on writing the metadata and the checkpoint information to the non-volatile memory.

Aspect 17: The method, apparatus, or non-transitory computer-readable medium of any of aspects 12 through 16, further including operations, features, circuitry, logic, means, or instructions, or any combination thereof for receiving a command that indicates completion of the checkpoint procedure, where the size of the address tracking log is decreased based at least in part on the command.

Aspect 18: The method, apparatus, or non-transitory computer-readable medium of any of aspects 12 through 17, further including operations, features, circuitry, logic, means, or instructions, or any combination thereof for receiving a read command, or a write command for user data, where the where the size of the address tracking log is decreased based at least in part on the read command, or the write command for user data.

Aspect 19: The method, apparatus, or non-transitory computer-readable medium of any of aspects 12 through 18, further including operations, features, circuitry, logic, means, or instructions, or any combination thereof for receiving, during the checkpoint procedure, a cache command to transfer content from a cache to the non-volatile memory and a write command to write the checkpoint information to the non-volatile memory, where a portion of the metadata is written to the non-volatile memory based at least in part on the cache command, the checkpoint information is written to non-volatile memory based at least in part on the command, and the size of the address tracking log is decreased based at least in part on cache command and the write command.

It should be noted that the described techniques include possible implementations, and that the operations and the steps may be rearranged or otherwise modified and that other implementations are possible. Further, portions from two or more of the methods may be combined.

An apparatus is described. The following provides an overview of aspects of the apparatus as described herein:

Aspect 20: An apparatus, including: a non-volatile memory; and a controller coupled with the non-volatile memory and configured to cause the apparatus to: determine that a checkpoint procedure has been initiated, where the checkpoint procedure includes a metadata update phase, in which metadata for a file is written, to a non-volatile memory and a checkpoint update phase, in which checkpoint information about the metadata is written to the non-volatile memory; write, based at least in part on determining that the checkpoint procedure has been initiated, the metadata to the non-volatile memory using a first type of write operation that has lower latency than a second type of write operation supported by the non-volatile memory; and write, based at least in part on determining that the checkpoint procedure has been initiated and based at least in part on writing the metadata, the checkpoint information about the metadata to the non-volatile memory using the first type of write operation.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” refers to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

As used herein, the term “substantially” means that the modified characteristic (e.g., a verb or adjective modified by the term substantially) need not be absolute but is close enough to achieve the advantages of the characteristic.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed and second condition or action may occur directly as a result of the previous condition or action occurring independent of whether other conditions or actions occur. In some examples, a first condition or action may be performed and second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorous, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processor, firmware, or any combination thereof. If implemented in software executed by a processor, the functions may be stored on or transmitted over, as one or more instructions or code, a computer-readable medium. Other examples and implementations are within the scope of the disclosure and appended claims. For example, due to the nature of software, the described functions can be implemented using software executed by a processor, hardware, firmware, hardwiring, or combinations of any of these. Features implementing functions may also be physically located at various positions, including being distributed such that portions of functions are implemented at different physical locations.

For example, the various illustrative blocks and components described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may be implemented as a combination of computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
a non-volatile memory; and
a controller coupled with the non-volatile memory and configured to cause the apparatus to:
determine whether a checkpoint procedure has been initiated, wherein the checkpoint procedure comprises a metadata update phase in which metadata for a file is written to the non-volatile memory, and a checkpoint update phase in which checkpoint information about the metadata is written to the non-volatile memory;
write, based at least in part on determining that the checkpoint procedure has been initiated, the metadata to the non-volatile memory using a first type of write operation that has lower latency than a second type of write operation supported by the non-volatile memory; and
write, based at least in part on determining that the checkpoint procedure has been initiated and based at least in part on writing the metadata, the checkpoint information about the metadata to the non-volatile memory using the first type of write operation.

2. The apparatus of claim 1, wherein the controller is further configured to cause the apparatus to:
receive a write command that includes a flag associated with the metadata, wherein initiation of the checkpoint procedure is determined based at least in part on the write command.

3. The apparatus of claim 1, wherein the controller is further configured to cause the apparatus to:
receive a command that indicates initiation of the checkpoint procedure, wherein initiation of the checkpoint procedure is determined based at least in part on the command.

4. The apparatus of claim 1, wherein the controller is further configured to cause the apparatus to:
reserve a first set of memory blocks for writing the metadata using the first type of write procedure; and
reserve a second set of memory blocks for writing the checkpoint information using the first type of write procedure, wherein initiation of the checkpoint procedure is determined after reserving the first and second sets of memory blocks.

5. The apparatus of claim 1, wherein the controller is further configured to cause the apparatus to:
pause an operation based at least in part on determining that the checkpoint procedure has been initiated; and
resume the operation based at least in part on determining that the checkpoint procedure has ended.

6. The apparatus of claim 1, wherein the controller is further configured to cause the apparatus to:
increase, based at least in part on determining that the checkpoint procedure has been initiated, a size of an address tracking log that associates logical addresses from access commands with physical addresses of the non-volatile memory.

7. The apparatus of claim 6, wherein the controller is further configured to cause the apparatus to:
decrease the size of the address tracking log based at least in part on writing the metadata and the checkpoint information.

8. The apparatus of claim 1, wherein the controller is further configured to cause the apparatus to:
receive, during the checkpoint procedure, a cache command to transfer content from a cache to the non-volatile memory, wherein a portion of the metadata is written to the non-volatile memory based at least in part on the cache command; and
receive, during the checkpoint procedure, a write command to write the checkpoint information to the non-volatile memory, wherein the checkpoint information is written to the non-volatile memory based at least in part on the write command.

9. The apparatus of claim 8, wherein the controller is further configured to cause the apparatus to:
store, based at least in part on the cache command and the write command, an indication to write the portion of the metadata to the non-volatile memory before writing the checkpoint information to the non-volatile memory; and
transmit a confirmation for the cache command based at least in part on storing the indication, wherein the confirmation is transmitted before the portion of the metadata is written to the non-volatile memory.

10. The apparatus of claim 9, wherein the controller is further configured to cause the apparatus to:
transmit a confirmation for the write command based at least in part on storing the indication, wherein the confirmation for the write command is transmitted before the checkpoint information is written to the non-volatile memory.

11. The apparatus of claim 1, wherein the first type of write operation stores a first quantity of bits per cell and the second type of write operation stores a second quantity of bits per cell, the second quantity larger than the first quantity.

12. An apparatus, comprising:
a non-volatile memory; and
a controller coupled with the non-volatile memory and configured to cause the apparatus to:
determine whether a checkpoint procedure has been initiated, wherein the checkpoint procedure comprises a metadata update phase in which metadata for a file is written to the non-volatile memory, and a checkpoint update phase in which checkpoint information about the metadata is written to the non-volatile memory;
increase, based at least in part on determining that the checkpoint procedure has been initiated, a size of an address tracking log that associates logical addresses from access commands with physical addresses of the non-volatile memory;
write, metadata and the checkpoint information about the metadata to the non-volatile memory based at least in part on determining that the checkpoint procedure has been initiated; and
decrease, based at least in part on writing the metadata and the checkpoint information using the increased size of the address tracking log, the size of the address tracking log.

13. The apparatus of claim 12, wherein the controller is further configured to cause the apparatus to:
receive a write command that includes a flag associated with the metadata, wherein initiation of the checkpoint procedure is determined based at least in part on the write command.

14. The apparatus of claim 12, wherein the controller is further configured to cause the apparatus to:
receive a command that indicates initiation of the checkpoint procedure, wherein initiation of the checkpoint procedure is determined based at least in part on the command.

15. The apparatus of claim 12, wherein the controller is further configured to cause the apparatus to:
write, based at least in part on determining that the checkpoint procedure has been initiated, the metadata and the checkpoint information to the non-volatile memory using a first type of write operation that has lower latency than a second type of write operation supported by the non-volatile memory.

16. The apparatus of claim 12, wherein the controller is further configured to cause the apparatus to:
pause an operation based at least in part on determining that the checkpoint procedure has been initiated; and
resume the operation based at least in part on writing the metadata and the checkpoint information to the non-volatile memory.

17. The apparatus of claim 12, wherein the controller is further configured to cause the apparatus to:
receive a command that indicates completion of the checkpoint procedure, wherein the size of the address tracking log is decreased based at least in part on the command.

18. The apparatus of claim 12, wherein the controller is further configured to cause the apparatus to:
receive a write command for user data, wherein the size of the address tracking log is decreased based at least in part on the write command for user data.

19. The apparatus of claim 12, wherein the controller is further configured to cause the apparatus to:
receive, during the checkpoint procedure, a cache command to transfer content from a cache to the non-volatile memory and a write command to write the checkpoint information to the non-volatile memory, wherein a portion of the metadata is written to the non-volatile memory based at least in part on the cache command, the checkpoint information is written to non-volatile memory based at least in part on the write command, and the size of the address tracking log is decreased based at least in part on cache command and the write command.

20. A method, comprising:
determining whether a checkpoint procedure has been initiated, wherein the checkpoint procedure comprises a metadata update phase, in which metadata for a file is written, to a non-volatile memory and a checkpoint update phase, in which checkpoint information about the metadata is written to the non-volatile memory;
writing, based at least in part on determining that the checkpoint procedure has been initiated, the metadata to the non-volatile memory using a first type of write operation that has lower latency than a second type of write operation supported by the non-volatile memory; and
writing, based at least in part on determining that the checkpoint procedure has been initiated and based at least in part on writing the metadata, the checkpoint information about the metadata to the non-volatile memory using the first type of write operation.
